(19) United States
(12) Patent Application Publication
(10) Pub. No.: US 2017/0158076 A1
(43) Pub. Date: Jun. 8, 2017

(54) DEVICE AND METHOD FOR REGENERATING A RECHARGEABLE METAL-AIR BATTERY, RECHARGEABLE METAL-AIR BATTERY, AND VEHICLE

(71) Applicant: Robert Bosch GmbH, Stuttgart (DE)

(72) Inventor: Markus KOHLBERGER, Stuttgart (DE)

(21) Appl. No.: 15/321,483

(22) PCT Filed: Jun. 8, 2015
(86) PCT No.: PCT/EP2015/062695

§ 371 Date: Dec. 22, 2016

(30) Foreign Application Priority Data
Jun. 25, 2014 (DE) 10 2014 212 144.2

(51) Int. Cl. B60L 11/18; H02J 7/00; H01M 10/44; H01M 12/08; H01M 10/42

(52) U.S. Cl. CPC B60L 11/1838; H01M 12/08; H01M 10/4242; H01M 10/44; H02J 7/0045; H02J 7/0027; B60L 11/1818; H01M 2220/20

(57) ABSTRACT

Disclosed is a device (100) for regenerating a rechargeable metal-air battery (210) for a vehicle (200), characterized by: an electrical unit (130) for charging or discharging the rechargeable metal-ion battery (210); and a gas supplying unit (110) for delivering oxygen or pure oxygen to the rechargeable metal-air battery (210) while the battery (210) is being discharged; the regeneration device (100) is located outside the vehicle (200). Also disclosed are a rechargeable metal-air battery (210), a vehicle (200) and a method.

### BACKGROUND OF THE INVENTION

It is foreseeable that, in mobile applications, for example in electric motor vehicles (electric vehicles, EV) or hybrid vehicles (hybrid electric vehicles, HEV), as rechargeable electrical energy stores (EES), increasing use will be made of new battery systems, for example with metal-air accumulators, such as lithium-air accumulators, or metal-oxygen accumulators, such as lithium-oxygen accumulators.

Lithium-oxygen accumulators comprise a negative electrode (anode) composed of metallic lithium and an oxygen (O₂)-based positive electrode (cathode). During the charging of the accumulator, oxygen is released at the positive electrode, and metallic lithium is deposited on the negative electrode. During the discharging of the accumulator, at the negative electrode, with the release of an electron, a positive lithium ion is released via an electrolyte to the positive electrode, where the lithium ion is oxidized with oxygen firstly to form lithium oxide (Li₂O) and thereafter to form lithium peroxide (Li₂O₂). Lithium-air accumulators have a high energy density.

The oxygen may be provided by the ambient air (lithium-air accumulator). Here, it is for example possible for air moisture, carbon dioxide (CO₂) and/or pollutants in the ambient air to lead to secondary reactions which can reduce the capacity, performance and/or service life of the accumulator or of the accumulator cells thereof. This can be prevented by purification of the air, which is cumbersome. A corresponding unit for the purification of the air (air purification unit), which is assigned to the accumulator and which must be arranged in and carried on board a vehicle, reduces the energy density of the overall system comprising accumulator and air purification unit.

The presentation document “Li-Air and Li-Sulfur in an Automotive System Context”, Thomas Greszler et al, Beyond Lithium Ion 5: Symposium on Scalable Energy Storage, Berkeley, Calif., US, Jun. 5-7, 2012, for example, includes a depiction of an Li-air system.

To improve the functionality of the accumulators (batteries) and accumulator systems (battery systems) and increase the service life of the accumulator cells (battery cells), it is therefore necessary to improve the treatment of the air.

### SUMMARY OF THE INVENTION

The devices and methods according to the invention have the advantage that the air purification unit in the vehicle can be omitted. In this way, the accumulator (battery), metal-air accumulator, such as lithium-air accumulator, or metal-oxygen accumulator, such as lithium-air accumulator, and/or the accumulator system (battery system) of the vehicle, can be simplified. It is thus possible for the outlay in the vehicle and the weight of the vehicle to be reduced. Here, the accumulator may be regenerated at a static regeneration device (station), for example public station, private station or home, and/or at intervals. Furthermore, the capacity and/or service life of the accumulator or of the accumulator cells (battery cells) can be increased. In this way, the costs, for example production costs, operating costs, driving costs and maintenance costs of the accumulator and/or of the vehicle can be reduced.

The device may expediently furthermore comprise a gas hose, for example a flexible gas hose, which is connected to the gas supply unit and which serves for the connection of the gas supply unit to a gas connector of the metal-air accumulator. In this way, the supply of the oxygen can be simplified and/or improved.

The device may expediently furthermore comprise an electrical cable for the connection of the electrical unit to an electrical connector of the metal-air accumulator. In this way, the transfer of the electrical energy can be simplified and/or improved.

Furthermore, the device may expediently comprise a combined connector piece which is connectable to a corresponding combined connector of the metal-air accumulator and which serves for the common connection of the gas hose and of the electrical cable to the metal-air accumulator. In this way, the connection of the gas hose and of the electrical cable can be simplified and/or improved. Furthermore, the time required for the connection can be reduced.

The gas supply unit may expediently be designed such that it can remove air moisture from ambient air. In this way, the regeneration of the metal-air accumulator can be improved. It is thus possible for the capacity and/or service life of the accumulator or of the accumulator cells to be further increased.

The gas supply unit may expediently be designed such that it can remove carbon dioxide from the ambient air. In this way, the regeneration of the metal-air accumulator can be improved. It is thus possible for the capacity and/or service life of the accumulator or of the accumulator cells to be further increased.

The gas supply unit may expediently be designed such that it can remove pollutants from the ambient air. In this way, the regeneration of the metal-air accumulator can be improved. It is thus possible for the capacity and/or service life of the accumulator or of the accumulator cells to be further increased.

The gas supply unit may expediently be designed such that it can, from the ambient air, generate air with a higher oxygen content. In this way, the regeneration of the metal-air accumulator can be improved. It is thus possible for the capacity and/or service life of the accumulator or of the accumulator cells to be further increased.

The gas supply unit may expediently be designed such that it can add an inert gas, noble gas or argon to the oxygen. In this way, the regeneration of the metal-air accumulator can be improved. It is thus possible for the capacity and/or service life of the accumulator or of the accumulator cells to be further increased.

The device may expediently furthermore comprise an energy store unit, for example an accumulator or a capacitor, which is connected to the electrical unit and which serves for storing electrical energy which, during the discharging, is transferred from the metal-air accumulator into the regeneration device. In this way, during the regeneration, for which the metal-air accumulator is discharged, a loss of energy can be lessened or at least reduced. It is thus possible for efficiency to be increased and costs to be reduced.

The device may expediently furthermore comprise a transfer unit which is connected to the electrical unit and which serves for transferring electrical energy, which is released from the metal-air accumulator during the discharging, into a further metal-air accumulator, which is arranged for example in a further vehicle. In this way, efficiency can be further increased, and the time for the regeneration can be reduced.

The device may expediently furthermore comprise a gas store unit, for example a gas bottle, which is connected to the gas supply unit and which serves for storing and/or providing the oxygen. In this way, an air purification unit in the regeneration device can be omitted. It is thus possible for the costs of the regeneration device to be reduced. In this way, a greater number of regeneration devices can be deployed. Easier access to regeneration can thus be realized.

The device may expediently furthermore comprise a control unit which is connected to the electrical unit and to the gas supply unit and which serves for controlling the electrical unit and the gas supply unit during the charging or discharging. In this way, the functionality and reliability of the regeneration device can be increased.

The invention also provides a metal-air accumulator which is connectable to the above-described regeneration device.

The invention also provides a vehicle, in particular motor vehicle such as electric motor vehicle, hybrid vehicle or electric motorcycle (electric bike, E-bike), electric bicycle (Pedal Electric Cycle, Pedelec), a marine vehicle such as an electric boat or submarine, an aircraft or a spacecraft, which comprises the above-described metal-air accumulator connected to the vehicle.

The method may expediently furthermore comprise, before the discharging, charging the metal-air accumulator by way of the regeneration device. In this way, the regeneration of the metal-air accumulator during the discharging can be improved.

The method may expediently furthermore comprise, before the charging or discharging, firstly connecting, for example automatically connecting, the regeneration device and the metal-air accumulator. By virtue of the connection being incorporated into the method for regeneration, the method can be further improved.

The connection may expediently comprise connecting a gas hose of the regeneration device to a gas connector of the metal-air accumulator for the supply of oxygen to the metal-air accumulator. In this way, the supply of the oxygen can be made possible.

The connection may expediently comprise connecting an electrical cable of the regeneration device to an electrical connector of the metal-air accumulator for the transfer of electrical energy. In this way, the transfer of the electrical energy can be made possible.

The discharging may expediently comprise transferring electrical energy from the metal-air accumulator into the regeneration device during the discharging. In this way, during the regeneration, for which the metal-air accumulator is discharged, a loss of energy can be lessened or at least reduced. It is thus possible for efficiency to be increased and costs to be reduced.

The discharging may expediently comprise storing the transferred electrical energy in an energy store unit of the regeneration device or in a further metal-air accumulator. In this way, during the regeneration, for which the metal-air accumulator is discharged, the loss of energy can be further lessened or reduced. It is thus possible for efficiency to be further increased and costs to be further reduced.

Further features and advantages of the present invention will become apparent to a person skilled in the art from the following description of exemplary embodiments, which are however not be interpreted as restricting the invention, with reference to the appended drawings.

### BRIEF DESCRIPTION OF THE DRAWING

FIG. 1 shows a schematic view of an exemplary system 10 for the regeneration of a metal-air accumulator 210, which is arranged in a vehicle 200, by way of a regeneration device 100 as per an embodiment of the invention.

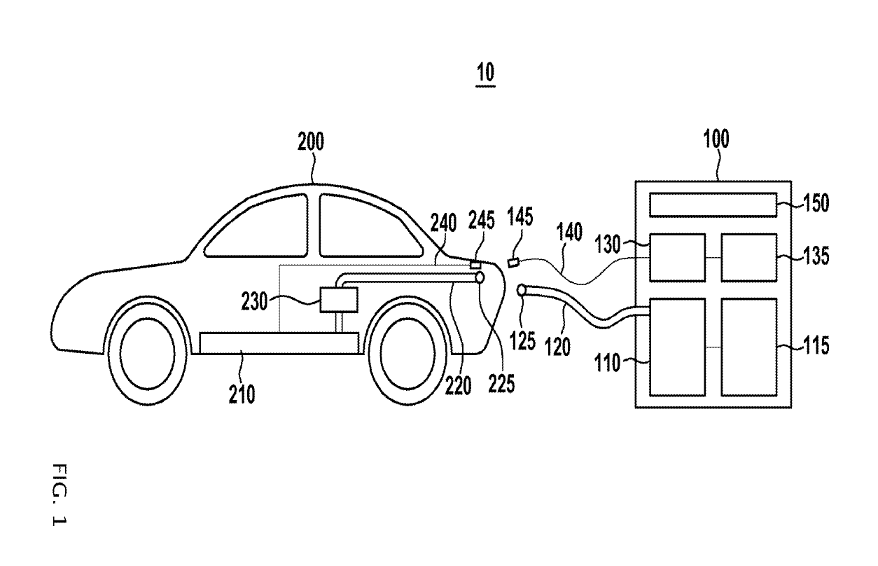

### DETAILED DESCRIPTION

The metal-air accumulator 210, which serves for example as a traction battery of the vehicle 200, comprises an electrical connector 245 by way of which the metal-air accumulator 210 can be charged by way of electrical energy and can be discharged for the release of the stored electrical energy. The electrical connector 245 may for example be of bipolar form (“positive” and “negative” or “positive” and “ground”). The electrical connector 245 may be connected to the metal-air accumulator via an electrical line 240. The metal-air accumulator 210 furthermore comprises a gas connector 225 via which air, such as purified air or oxygen such as pure oxygen, can be supplied to the metal-air accumulator 210 or the positive electrode thereof during regeneration thereof. The gas connector 225 may be connected to the metal-air accumulator 210 via a gas line 220. The gas line 220 may for example be in the form of a gas pipe or gas hose. The electrical connector 245 and the gas connector 225 may, as shown by way of example in the figure, be formed separately from one another. It is alternatively possible for the electrical connector 245 and the gas connector 225 to be in the form of a combined connector.

The metal-air accumulator 210 may furthermore comprise an air filter 230 for purification of the air for the operation of said metal-air accumulator while the vehicle 200 is travelling. As shown by way of example in the figure, the air filter may be arranged along the gas line 220. Alternatively, the air filter 230 may be arranged directly at the metal-air accumulator 210.

The regeneration device 100, which, as shown by way of example in the figure, is arranged outside the vehicle 200, comprises an electrical unit 130 for charging and/or discharging the metal-air accumulator 210, and comprises a gas supply unit 110 for the supply of oxygen, for example pure oxygen, to the metal-air accumulator 210 during the discharging of the metal-air accumulator 210. The regeneration device 100 may furthermore comprise a gas hose 120, which is connected to the gas supply unit 110 and which serves for the connection of the gas supply unit 110 to the gas connector 225 of the metal-air accumulator 210, and/or an electrical cable 140, which serves for the connection of the electrical unit 130 to the electrical connector 245 of the metal-air accumulator 210. As shown by way of example in the figure, the regeneration device 100 may furthermore comprise, at a free end of the gas hose 120 and at a free end of the electrical cable 140, in each case one connector piece 125, 145 for the connection of the gas hose 120 and of the electrical cable 140 respectively to the metal-air accumulator 210. Alternatively, the regeneration device 100 may comprise a combined connector piece which is connectable to the combined connector of the metal-air accumulator 210 and which serves for the common connection of the gas hose 120 and of the electrical cable 140 to the metal-air accumulator 210.

As shown by way of example in the figure, the regeneration device 100 may furthermore comprise an energy store unit 135 which is connected to the electrical unit 130 and which serves for storing electrical energy which is transferred from the metal-air accumulator 210 into the regeneration device 110 during the discharging. The energy store unit 135 may be in the form of an accumulator or capacitor.

The regeneration device 100 may furthermore comprise a transfer unit which is connected to the electrical unit 130 and which serves for transferring electrical energy that is released from the metal-air accumulator during the discharging into a further metal-air accumulator. For this purpose, the regeneration device 100 may comprise a further gas hose and/or a further electrical cable with further connector pieces or a further combined connector piece. The further metal-air accumulator may for example be arranged in a further vehicle, such that the electrical energy released during the discharging of the metal-air accumulator 210 can be used for charging the already previously discharged further metal-air accumulator.

The gas supply unit 110 may be designed for purifying ambient air. For this purpose, the gas supply unit 110 may remove air moisture, carbon dioxide and/or pollutants from the ambient air. Furthermore, the gas supply unit 110 may possibly increase the oxygen content in the air, for example by separation or binding of other constituents and/or by way of a release of oxygen. Furthermore, the gas supply unit 110 may add an inert gas to the air. A noble gas such as argon, for example, may serve as inert gas. The gas supply unit 110 may, for this purpose, comprise for example a supercharging blower, a compressor, a cooler and/or a separator, such as a separator for water and/or carbon dioxide.

The regeneration device 100 may furthermore comprise a gas store unit 115 which is connected to the gas supply unit 110 and which serves for storing or providing the oxygen and/or the inert gas. The gas store unit 115 may be in the form of a gas bottle. The gas store unit 115 may be used for receiving and storing purified ambient air. It is thus possible for the purification, which requires electrical energy, and the regeneration to be performed separately in terms of time. It is thus possible, for example, for the purification to take place when the costs for the electrical energy are low, or when alternative energy is available.

The regeneration device 100 may furthermore comprise a control unit 150 which is connected to the electrical unit 130 and to the gas supply unit 110 and which serves for controlling the electrical unit 130 and the gas supply unit 110 during the charging or discharging.

Before the regeneration of the metal-air accumulator, the regeneration device 100 and the metal-air accumulator 210 are firstly connected to one another. For this purpose, the gas hose 120 of the regeneration device 100 for the supply of oxygen to the metal-air accumulator 210 is connected to the gas connector 225 of the metal-air accumulator 210, and the electrical cable 140 of the regeneration device 100 for the transfer of electrical energy during the charging and/or discharging is connected to the electrical connector 145 of the metal-air accumulator 210. If the metal-air accumulator 210 is not fully charged, it may firstly be charged by way of the regeneration device 100.

For the regeneration of the metal-air accumulator 210, the metal-air accumulator 210 is discharged with a supply of oxygen from the regeneration device 100. The released electrical energy may for example be stored in the energy store unit 135 or used for charging the further metal-air accumulator. The oxygen may be supplied for example in the form of purified ambient air, pure oxygen or oxygen with argon. In this way, the positive electrode of the metal-air accumulator 210 is purified and regenerated.

Subsequently, the metal-air accumulator 210 is recharged by way of the regeneration device 100. The regeneration device 100 may draw the electrical energy required for the charging by way of an electrical supply from the public electrical grid. The electrical supply may for example comprise a power adapter such as a switching power adapter and/or a transformer. Alternatively, the regeneration device 100 may generate the electrical energy required for the charging for example by way of a solar cell and/or a wind turbine. Alternatively, the regeneration device 100 may draw the electrical energy required for the charging, as described above, from the energy store unit 135 or from some other metal-air accumulator that is presently discharged for regeneration purposes.

To maintain the capacity and lengthen the service life of the metal-air accumulator 210, the regeneration is performed repeatedly. Here, the regeneration is performed at regular intervals, for example in each case after a predetermined number of charging/discharging cycles or at servicing intervals, or when required, for example if the capacity falls below a predetermined value. The regeneration may be performed for example at servicing locations such as workshops, refueling stations or recharging stations, in parking lots or in home garages.

Finally, it is pointed out that expressions such as “comprising” and “having” or the like do not rule out the possible provision of further elements or steps. Furthermore, it is pointed out that the expressions “a” or “an” do not rule out a multiplicity. Furthermore, the features described in conjunction with the various embodiments may be combined with one another in any desired manner. Finally, it is pointed out that the reference designations in the claims should not be interpreted as restricting the scope of protection of the claims.

1. A device (100) for regenerating a metal-air accumulator (210) of a vehicle (200), the device comprising:
an electrical unit (130) for charging or discharging the metal-air accumulator (210), and
a gas supply unit (110) for supplying oxygen or pure oxygen to the metal-air accumulator (210) during the discharging of the metal-air accumulator (210), wherein
the regeneration device (100) is configured to be arranged outside the vehicle (200).

2. The device (100) as claimed in claim 1, furthermore comprising:
a gas hose (120) which is connected to the gas supply unit (110) and which serves for the connection of the gas supply unit (110) to a gas connector (225) of the metal-air accumulator (210).

3. The device (100) as claimed in claim 1, furthermore comprising:
a combined connector piece which is connectable to a corresponding combined connector of the metal-air accumulator (210) and which serves for the common connection of the gas hose (120) and of the electrical cable (140) to the metal-air accumulator (210).

4. (canceled)

5. The device (100) as claimed in claim 1, furthermore comprising:
an energy store unit (135), an accumulator or a capacitor, which is connected to the electrical unit (130) and which serves for storing electrical energy which, during the discharging, is transferred from the metal-air accumulator (210) into the regeneration device (100).

6. (canceled)

7. (canceled)

8. A method for regenerating a metal-air accumulator (210) of a vehicle (200) using a regeneration device (100), the method comprising:
discharging the metal-air accumulator (210) with a supply of oxygen or pure oxygen from the regeneration device (100), and
recharging the metal-air accumulator (210) by way of the regeneration device (100), wherein
the regeneration device (100) is arranged outside the vehicle (200).

9. The method as claimed in claim 8, furthermore comprising:
before the discharging, charging the metal-air accumulator (210) by way of the regeneration device (100).

10. The method as claimed in claim 8, furthermore comprising:
before the charging or discharging, firstly connecting the regeneration device (100) and the metal-air accumulator (210).

11. The method as claimed in claim 10, wherein the connection comprises:
connecting a gas hose (120) of the regeneration device (100) to a gas connector (225) of the metal-air accumulator (210) for the supply of oxygen to the metal-air accumulator (210).

12. The method as claimed in claim 8, wherein the discharging comprises:
transferring electrical energy from the metal-air accumulator (210) into the regeneration device (110) during the discharging, and
storing the transferred electrical energy in an energy store unit (135) of the regeneration device (100) or in a further the metal-air accumulator.

13. The method as claimed in claim 10, wherein the connection comprises:
connecting an electrical cable (140) of the regeneration device (100) to an electrical connector (145) of the metal-air accumulator (210) for the transfer of electrical energy.

14. The device (100) as claimed in claim 1, furthermore comprising:
an electrical cable (140) for the connection of the electrical unit (130) to an electrical connector (245) of the metal-air accumulator (210).

15. The device (100) as claimed in claim 1, wherein the gas supply unit (110) is configured to remove air moisture from ambient air,
can remove carbon dioxide from the ambient air,
can remove pollutants from the ambient air,
can, from the ambient air, generate air with a higher oxygen content, or
can add an inert gas, noble gas or argon to the oxygen.

16. The device (100) as claimed in claim 1, wherein the gas supply unit (110) is configured to remove air moisture from ambient air.

17. The device (100) as claimed in claim 1, wherein the gas supply unit (110) is configured to remove carbon dioxide from the ambient air.

18. The device (100) as claimed in claim 1, wherein the gas supply unit (110) is configured to remove pollutants from the ambient air.

19. The device (100) as claimed in claim 1, wherein the gas supply unit (110) is configured to, from the ambient air, generate air with a higher oxygen content.

20. The device (100) as claimed in claim 1, wherein the gas supply unit (110) is configured to add an inert gas, noble gas or argon to the oxygen.

21. The device (100) as claimed in claim 1, furthermore comprising:
a transfer unit which is connected to the electrical unit (130) and which serves for transferring electrical energy, which is released from the metal-air accumulator during the discharging, into a further metal-air accumulator.

22. The device (100) as claimed in claim 1, furthermore comprising:
a gas store unit (115) or a gas bottle which is connected to the gas supply unit (110) and which serves for storing and/or providing the oxygen.

23. The device (100) as claimed in claim 1, furthermore comprising:
a control unit (150) which is connected to the electrical unit (130) and to the gas supply unit (110) and which serves for controlling the electrical unit (130) and the gas supply unit (110) during the charging or discharging.
